(19) United States
(12) Patent Application Publication
(10) Pub. No.: US 2008/0133859 A1
(43) Pub. Date: Jun. 5, 2008

(54) Advanced synchronization and contention resolution

(76) Inventor: John M. Holt, Essex (GB)

Correspondence Address: PERKINS COIE LLP, P.O. BOX 2168, MENLO PARK, CA, 94026, US

(21) Appl. No.: 11/973,370

(22) Filed: Oct. 5, 2007

Related U.S. Application Data
(60) Provisional application No. 60/850,713, filed on Oct. 9, 2006.
(60) Provisional application No. 60/850,711, filed on Oct. 9, 2006.

(30) Foreign Application Priority Data
Oct. 5, 2006 (AU) 2006905524(5027U)
Oct. 5, 2006 (AU) 2006905527(5027T)

(51) Int. Cl. G06F 15/167; G06F 12/14

(52) U.S. Cl. 711/163; 709/212; 711/E12.091

(57) ABSTRACT

A multiple computer environment is disclosed in which an application program executes simultaneously on a plurality of computers (M1, M2, . . . Mn) interconnected by a communications network (3) and in which the local memory of each computer is maintained substantially the same by updating in due course. A lock mechanism is provided to permit exclusive access to an asset, object, or structure (ie memory location) by acquisition and release of the lock. In particular, before a new lock can be acquired by any other computer on a memory location previously locked by one computer, any updating count(s) for the previously locked memory location are transmitted to all the other computers and their corresponding memory locations (before the in due course updating). Thus the lock acquiring computer can ascertain if its local memory has been adequately updated.

### CROSS-REFERENCE TO RELATED APPLICATIONS

The present application claims the benefit of priority to U.S. Provisional Application Nos. 60/850,713 (5027U-US) and 60/850,711 (5027T-US), both filed on 9 Oct. 2006; and to Australian Provisional Application Nos. 2006905524 (5027U-AU) and 2006905527 (5027T-AU), both filed on 5 Oct. 2006, each of which are hereby incorporated herein by reference.

This application is related to concurrently filed U.S. Application entitled “Advanced Synchronization and Contention Resolution,” (Attorney Docket No. 61130-8020.US01 (5027U-US01)) and concurrently filed U.S. Application entitled “Advanced Synchronization and Contention Resolution,” (Attorney Docket No. 61130-8020.US02 (5027U-US02)), each of which are hereby incorporated herein by reference.

### FIELD OF THE INVENTION

The present invention relates to computing and, in particular, to the simultaneous operation of a plurality of computers interconnected via a communications network.

### BACKGROUND

International Patent Application No. PCT/AU2005/000580 (Attorney Ref 5027F-WO) published under WO 2005/103926 (to which U.S. patent application Ser. No. 11/111,946 and published under No. 2005-0262313 corresponds) in the name of the present applicant, discloses how different portions of an application program written to execute on only a single computer can be operated substantially simultaneously on a corresponding different one of a plurality of computers. That simultaneous operation has not been commercially used as of the priority date of the present application. International Patent Application Nos. PCT/AU2005/001641 (WO 2006/110,937) (Attorney Ref 5027F-D1-WO) to which U.S. patent application Ser. No. 11/259,885 entitled: “Computer Architecture Method of Operation for Multi-Computer Distributed Processing and Co-ordinated Memory and Asset Handling” corresponds and PCT/AU2006/000532 (WO 2006/110,957) (Attorney Ref: 5027F-D2-WO) both in the name of the present applicant and both unpublished as at the priority date of the present application, also disclose further details. The contents of the specification of each of the abovementioned prior application(s) are hereby incorporated into the present specification by cross reference for all purposes.

Briefly stated, the abovementioned patent specifications disclose that at least one application program written to be operated on only a single computer can be simultaneously operated on a number of computers each with independent local memory. The memory locations required for the operation of that program are replicated in the independent local memory of each computer. On each occasion on which the application program writes new data to any replicated memory location, that new data is transmitted and stored at each corresponding memory location of each computer. Thus apart from the possibility of transmission delays, each computer has a local memory the contents of which are substantially identical to the local memory of each other computer and are updated to remain so. Since all application programs, in general, read data much more frequently than they cause new data to be written, the abovementioned arrangement enables very substantial advantages in computing speed to be achieved. In particular, the stratagem enables two or more commodity computers interconnected by a commodity communications network to be operated simultaneously running under the application program written to be executed on only a single computer.

In many situations, the above-mentioned arrangements work satisfactorily. This applies particularly where the programmer is aware that there may be updating delays and so can adjust the flow of the program to account for this. However, there are situations in which the use of stale contents or values instead of the latest content can create problems.

### GENESIS OF THE INVENTION

The genesis of the present invention is a desire to at least partially overcome the abovementioned difficulty.

### SUMMARY OF THE INVENTION

In accordance with a first aspect of the present invention there is disclosed a multiple computer environment in which a different portion of an application program written to execute on only a single computer executes substantially simultaneously on a corresponding one of a plurality of computers, each having a independent local memory and each being interconnected via a communications network, and in which at least one application memory location/content is replicated in the independent local memory of each said computer, and after each occasion at which each said replicated application memory location/content has its contents written to, or re-written, with a new content, an updating count (“count value”) indicative of the sequence of updating is associated with the corresponding memory location, and all said corresponding memory locations of said computers are in due course updated via said communications network with said new content and new updating count, the further improvement comprising the steps of:

(i) prior to initially writing said new content, acquiring a replicated lock on an object, asset or resource,

(ii) recording the identity/name and updating count of all said local replica application memory locations/contents written to prior to releasing said lock,

(iii) releasing said replicated lock, and

(iv) prior to permitting the acquisition of the same replicated lock by another one of said computers, transmitting said updated application memory location(s)/content(s) and associated most recent updating count(s) to said another one computer, whereby any said computer on acquiring said lock has updated the local replica application memory location(s)/content(s) with the updated value(s)/content(s) associated with said most recent updating count(s).

In accordance with a second aspect of the present invention there is disclosed a computer system comprising a plurality of computers each having an independent local memory and each being interconnected via a communications network wherein a different portion of an application program written to execute on only a single computer executes substantially simultaneously on a corresponding one of said plurality of computers, at least one application memory location/content replicated in the independent local memory of each said computer, said replicated application memory location/content including an updating count indicative of the sequence of updating of said replicated application memory location/content, said system further comprising updating means associated with each said computer to in due course update each said replicated application memory location/content via said communications network after each occasion at which each said replica application memory location/content has its content written to, or re-written, with a new content, and an associated new updating count, and lock means associated with each said computer to acquire a replicated lock on an object, asset or resource, said replicated lock means including a recording means in which is recorded the name/identity and updating count of all said replica application memory locations/contents written to prior to releasing said lock, and said replicated lock means after releasing said lock and prior to permitting the acquisition of the same lock by another one of said machines transmitting said updated replica application memory location(s)/content(s) and corresponding updating count(s) to said another one machine, whereby any said machine on acquiring said lock has updated the local replica application memory location(s)/content(s) with the updated value(s)/content(s) associated with said most recent updating count(s).

### BRIEF DESCRIPTION OF DRAWINGS

Preferred embodiments of the present invention will now be described with reference to the drawings in which:

FIG. 1A is a schematic illustration of a prior art computer arranged to operate JAVA code and thereby constitute a single JAVA virtual machine,

FIG. 1B is a drawing similar to FIG. 1A but illustrating the initial loading of code,

FIG. 1C illustrates the interconnection of a multiplicity of computers each being a JAVA virtual machine to form a multiple computer system,

FIG. 2 schematically illustrates “n” application running computers to which at least one additional server machine X is connected as a server,

FIG. 2A is a schematic representation of an RSM multiple computer system,

FIG. 2B is a similar schematic representation of a partial or hybrid RSM multiple computer system

FIGS. 3 and 4 are flowcharts respectively illustrating the acquire lock and release lock procedures of a first embodiment, and

FIGS. 5 and 6 are flowcharts illustrating the respective procedures of a second embodiment.

### DETAILED DESCRIPTION

The embodiments will be described with reference to the JAVA language, however, it will be apparent to those skilled in the art that the invention is not limited to this language and, in particular can be used with other languages (including procedural, declarative and object oriented languages) including the MICROSOFT.NET platform and architecture (Visual Basic, Visual C, and Visual C++, and Visual C#), FORTRAN, C, C++, COBOL, BASIC and the like.

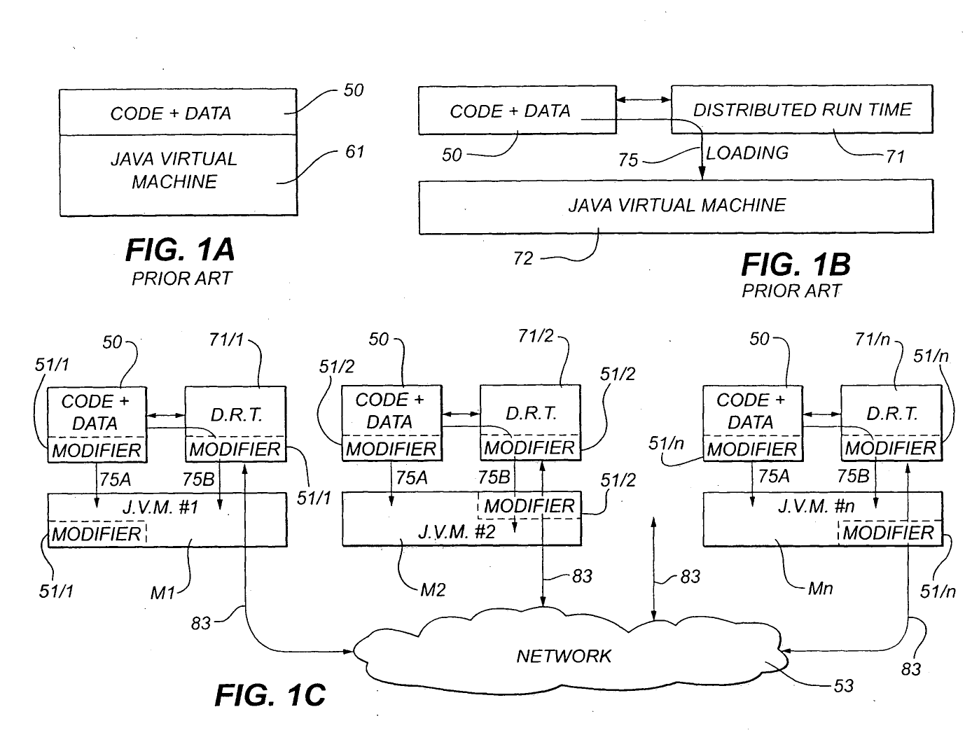

It is known in the prior art to provide a single computer or machine (produced by any one of various manufacturers and having an operating system (or equivalent control software or other mechanism) operating in any one of various different languages) utilizing the particular language of the application by creating a virtual machine as illustrated in FIG. 1A.

The code and data and virtual machine configuration or arrangement of FIG. 1A takes the form of the application code 50 written in the JAVA language and executing within the JAVA virtual machine 61. Thus where the intended language of the application is the language JAVA, a JAVA virtual machine is used which is able to operate code in JAVA irrespective of the machine manufacturer and internal details of the computer or machine. For further details, see “The JAVA Virtual Machine Specification” 2^{nd} Edition by T. Lindholm and F. Yellin of Sun Microsystems Inc of the USA which is incorporated herein by reference.

This conventional art arrangement of FIG. 1A is modified by the present applicant by the provision of an additional facility which is conveniently termed a “distributed run time” or a “distributed run time system” DRT 71 and as seen in FIG. 1B.

In FIGS. 1B and 1C, the application code 50 is loaded onto the Java Virtual Machine(s) M1, M2, . . . Mn in cooperation with the distributed runtime system 71, through the loading procedure indicated by arrow 75 or 75A or 75B. As used herein the terms “distributed runtime” and the “distributed run time system” are essentially synonymous, and by means of illustration but not limitation are generally understood to include library code and processes which support software written in a particular language running on a particular platform. Additionally, a distributed runtime system may also include library code and processes which support software written in a particular language running within a particular distributed computing environment. A runtime system (whether a distributed runtime system or not) typically deals with the details of the interface between the program and the operating system such as system calls, program start-up and termination, and memory management. For purposes of background, a conventional Distributed Computing Environment (DCE) (that does not provide the capabilities of the inventive distributed run time or distributed run time system 71 used in the preferred embodiments of the present invention) is available from the Open Software Foundation. This Distributed Computing Environment (DCE) performs a form of computer-to-computer communication for software running on the machines, but among its many limitations, it is not able to implement the desired modification or communication operations. Among its functions and operations the preferred DRT 71 coordinates the particular communications between the plurality of machines M1, M2, . . . Mn. Moreover, the preferred distributed runtime 71 comes into operation during the loading procedure indicated by arrow 75A or 75B of the JAVA application 50 on each JAVA virtual machine 72 or machines JVM#1, JVM#2, . . . JVM#n of FIG. 1C. It will be appreciated in light of the description provided herein that although many examples and descriptions are provided relative to the JAVA language and JAVA virtual machines so that the reader may get the benefit of specific examples, there is no restriction to either the JAVA language or JAVA virtual machines, or to any other language, virtual machine, machine or operating environment.

FIG. 1C shows in modified form the arrangement of the JAVA virtual machines, each as illustrated in FIG. 1B. It will be apparent that again the same application code 50 is loaded onto each machine M1, M2 . . . Mn. However, the communications between each machine M1, M2 . . . Mn are as indicated by arrows 83, and although physically routed through the machine hardware, are advantageously controlled by the individual DRT's 71/1 . . . 71/n within each machine. Thus, in practice this may be conceptionalised as the DRT's 71/1, . . . 71/n communicating with each other via the network or other communications link 53 rather than the machines M1, M2 . . . Mn communicating directly themselves or with each other. Contemplated and included is either this direct communication between machines M1, M2 . . . Mn or DRT's 71/1, 71/2 . . . 71/n or a combination of such communications. The preferred DRT 71 provides communication that is transport, protocol, and link independent.

The one common application program or application code 50 and its executable version (with likely modification) is simultaneously or concurrently executing across the plurality of computers or machines M1, M2 . . . Mn. The application program 50 is written to execute on a single machine or computer (or to operate on the multiple computer system of the abovementioned patent applications which emulate single computer operation). Essentially the modified structure is to replicate an identical memory structure and contents on each of the individual machines.

The term “common application program” is to be understood to mean an application program or application program code written to operate on a single machine, and loaded and/or executed in whole or in part on each one of the plurality of computers or machines M1, M2 . . . Mn, or optionally on each one of some subset of the plurality of computers or machines M1, M2 . . . Mn. Put somewhat differently, there is a common application program represented in application code 50. This is either a single copy or a plurality of identical copies each individually modified to generate a modified copy or version of the application program or program code. Each copy or instance is then prepared for execution on the corresponding machine. At the point after they are modified they are common in the sense that they perform similar operations and operate consistently and coherently with each other. It will be appreciated that a plurality of computers, machines, information appliances, or the like implementing the abovedescribed arrangements may optionally be connected to or coupled with other computers, machines, information appliances, or the like that do not implement the abovedescribed arrangements.

The same application program 50 (such as for example a parallel merge sort, or a computational fluid dynamics application or a data mining application) is run on each machine, but the executable code of that application program is modified on each machine as necessary such that each executing instance (copy or replica) on each machine coordinates its local operations on that particular machine with the operations of the respective instances (or copies or replicas) on the other machines such that they function together in a consistent, coherent and coordinated manner and give the appearance of being one global instance of the application (i.e. a “meta-application”).

The copies or replicas of the same or substantially the same application codes, are each loaded onto a corresponding one of the interoperating and connected machines or computers. As the characteristics of each machine or computer may differ, the application code 50 may be modified before loading, or during the loading process, or with some disadvantages after the loading process, to provide a customization or modification of the application code on each machine. Some dissimilarity between the programs or application codes on the different machines may be permitted so long as the other requirements for interoperability, consistency, and coherency as described herein can be maintained. As it will become apparent hereafter, each of the machines M1, M2. Mn and thus all of the machines M1, M2 . . . Mn have the same or substantially the same application code 50, usually with a modification that may be machine specific.

Before the loading of, or during the loading of, or at any time preceding the execution of, the application code 50 (or the relevant portion thereof) on each machine M1, M2 . . . Mn, each application code 50 is modified by a corresponding modifier 51 according to the same rules (or substantially the same rules since minor optimizing changes are permitted within each modifier 51/1, 51/2 . . . 51/n).

Each of the machines M1, M2 . . . Mn operates with the same (or substantially the same or similar) modifier 51 (in some embodiments implemented as a distributed run time or DRT 71 and in other embodiments implemented as an adjunct to the application code and data 50, and also able to be implemented within the JAVA virtual machine itself). Thus all of the machines M1, M2 . . . Mn have the same (or substantially the same or similar) modifier 51 for each modification required. A different modification, for example, may be required for memory management and replication, for initialization, for finalization, and/or for synchronization (though not all of these modification types may be required for all embodiments).

There are alternative implementations of the modifier 51 and the distributed run time 71. For example, as indicated by broken lines in FIG. 1C, the modifier 51 may be implemented as a component of or within the distributed run time 71, and therefore the DRT 71 may implement the functions and operations of the modifier 51. Alternatively, the function and operation of the modifier 51 may be implemented outside of the structure, software, firmware, or other means used to implement the DRT 71 such as within the code and data 50, or within the JAVA virtual machine itself. In one embodiment, both the modifier 51 and DRT 71 are implemented or written in a single piece of computer program code that provides the functions of the DRT and modifier. In this case the modifier function and structure is, in practice, subsumed into the DRT. Independent of how it is implemented, the modifier function and structure is responsible for modifying the executable code of the application code program, and the distributed run time function and structure is responsible for implementing communications between and among the computers or machines. The communications functionality in one embodiment is implemented via an intermediary protocol layer within the computer program code of the DRT on each machine. The DRT can, for example, implement a communications stack in the JAVA language and use the Transmission Control Protocol/Internet Protocol (TCP/IP) to provide for communications or talking between the machines. These functions or operations may be implemented in a variety of ways, and it will be appreciated in light of the description provided herein that exactly how these functions or operations are implemented or divided between structural and/or procedural elements, or between computer program code or data structures, is not important or crucial.

However, in the arrangement illustrated in FIG. 1C, a plurality of individual computers or machines M1, M2 . . . Mn are provided, each of which are interconnected via a communications network 53 or other communications link. Each individual computer or machine is provided with a corresponding modifier 51. Each individual computer is also provided with a communications port which connects to the communications network. The communications network 53 or path can be any electronic signalling, data, or digital communications network or path and is preferably a slow speed, and thus low cost, communications path, such as a network connection over the Internet or any common networking configurations including ETHERNET or INFINIBAND and extensions and improvements, thereto. Preferably, the computers are provided with one or more known communications ports (such as CISCO Power Connect 5224 Switches) which connect with the communications network 53.

As a consequence of the above described arrangement, if each of the machines M1, M2, . . . , Mn has, say, an internal or local memory capability of 10 MB, then the total memory available to the application code 50 in its entirety is not, as one might expect, the number of machines (n) times 10 MB. Nor is it the additive combination of the internal memory capability of all n machines. Instead it is either 10 MB, or some number greater than 10 MB but less than n×10 MB. In the situation where the internal memory capacities of the machines are different, which is permissible, then in the case where the internal memory in one machine is smaller than the internal memory capability of at least one other of the machines, then the size of the smallest memory of any of the machines may be used as the maximum memory capacity of the machines when such memory (or a portion thereof) is to be treated as ‘common’ memory (i.e. similar equivalent memory on each of the machines M1 . . . Mn) or otherwise used to execute the common application code.

However, even though the manner that the internal memory of each machine is treated may initially appear to be a possible constraint on performance, how this results in improved operation and performance will become apparent hereafter. Naturally, each machine M1, M2 . . . Mn has a private (i.e. ‘non-common’) internal memory capability. The private internal memory capability of the machines M1, M2, . . . , Mn are normally approximately equal but need not be. For example, when a multiple computer system is implemented or organized using existing computers, machines, or information appliances, owned or operated by different entities, the internal memory capabilities may be quite different. On the other hand, if a new multiple computer system is being implemented, each machine or computer is preferably selected to have an identical internal memory capability, but this need not be so.

It is to be understood that the independent local memory of each machine represents only that part of the machine's total memory which is allocated to that portion of the application program running on that machine. Thus, other memory will be occupied by the machine's operating system and other computational tasks unrelated to the application program 50.

Non-commercial operation of a prototype multiple computer system indicates that not every machine or computer in the system utilises or needs to refer to (e.g. have a local replica of) every possible memory location. As a consequence, it is possible to operate a multiple computer system without the local memory of each machine being identical to every other machine, so long as the local memory of each machine is sufficient for the operation of that machine. That is to say, provided a particular machine does not need to refer to (for example have a local replica of) some specific memory locations, then it does not matter that those specific memory locations are not replicated in that particular machine.

It may also be advantageous to select the amounts of internal memory in each machine to achieve a desired performance level in each machine and across a constellation or network of connected or coupled plurality of machines, computers, or information appliances M1, M2, . . . , Mn. Having described these internal and common memory considerations, it will be apparent in light of the description provided herein that the amount of memory that can be common between machines is not a limitation.

In some embodiments, some or all of the plurality of individual computers or machines can be contained within a single housing or chassis (such as so-called “blade servers” manufactured by Hewlett-Packard Development Company, Intel Corporation, IBM Corporation and others) or the multiple processors (eg symmetric multiple processors or SMPs) or multiple core processors (eg dual core processors and chip multithreading processors) manufactured by Intel, AMD, or others, or implemented on a single printed circuit board or even within a single chip or chipset. Similarly, also included are computers or machines having multiple cores, multiple CPU's or other processing logic.

When implemented in a non-JAVA language or application code environment, the generalized platform, and/or virtual machine and/or machine and/or runtime system is able to operate application code 50 in the language(s) (possibly including for example, but not limited to any one or more of source-code languages, intermediate-code languages, object-code languages, machine-code languages, and any other code languages) of that platform and/or virtual machine and/or machine and/or runtime system environment, and utilize the platform, and/or virtual machine and/or machine and/or runtime system and/or language architecture irrespective of the machine or processor manufacturer and the internal details of the machine. It will also be appreciated that the platform and/or runtime system can include virtual machine and non-virtual machine software and/or firmware architectures, as well as hardware and direct hardware coded applications and implementations.

For a more general set of virtual machine or abstract machine environments, and for current and future computers and/or computing machines and/or information appliances or processing systems, and that may not utilize or require utilization of either classes and/or objects, the structure, method and computer program and computer program product are still applicable. Examples of computers and/or computing machines that do not utilize either classes and/or objects include for example, the x86 computer architecture manufactured by Intel Corporation and others, the SPARC computer architecture manufactured by Sun Microsystems, Inc and others, the Power PC computer architecture manufactured by International Business Machines Corporation and others, and the personal computer products made by Apple Computer, Inc., and others.

For these types of computers, computing machines, information appliances, and the virtual machine or virtual computing environments implemented thereon that do not utilize the idea of classes or objects, may be generalized for example to include primitive data types (such as integer data types, floating point data types, long data types, double data types, string data types, character data types and Boolean data types), structured data types (such as arrays and records), derived types, or other code or data structures of procedural languages or other languages and environments such as functions, pointers, components, modules, structures, reference and unions. These structures and procedures when applied in combination when required, maintain a computing environment where memory locations, address ranges, objects, classes, assets, resources, or any other procedural or structural aspect of a computer or computing environment are where required created, maintained, operated, and deactivated or deleted in a coordinated, coherent, and consistent manner across the plurality of individual machines M1, M2 . . . Mn.

This analysis or scrutiny of the application code 50 can take place either prior to loading the application program code 50, or during the application program code 50 loading procedure, or even after the application program code 50 loading procedure (or some combination of these). It may be likened to an instrumentation, program transformation, translation, or compilation procedure in that the application code can be instrumented with additional instructions, and/or otherwise modified by meaning-preserving program manipulations, and/or optionally translated from an input code language to a different code language (such as for example from source-code language or intermediate-code language to object-code language or machine-code language). In this connection it is understood that the term “compilation” normally or conventionally involves a change in code or language, for example, from source code to object code or from one language to another language. However, in the present instance the term “compilation” (and its grammatical equivalents) is not so restricted and can also include or embrace modifications within the same code or language. For example, the compilation and its equivalents are understood to encompass both ordinary compilation (such as for example by way of illustration but not limitation, from source-code to object code), and compilation from source-code to source-code, as well as compilation from object-code to object code, and any altered combinations therein. It is also inclusive of so-called “intermediary-code languages” which are a form of “pseudo object-code”.

By way of illustration and not limitation, in one arrangement, the analysis or scrutiny of the application code 50 takes place during the loading of the application program code such as by the operating system reading the application code 50 from the hard disk or other storage device, medium or source and copying it into memory and preparing to begin execution of the application program code. In another arrangement, in a JAVA virtual machine, the analysis or scrutiny may take place during the class loading procedure of the java.lang.ClassLoader.loadClass method (e.g. “java.lang.ClassLoader.loadClass( )”).

Alternatively, or additionally, the analysis or scrutiny of the application code 50 (or of a portion of the application code) may take place even after the application program code loading procedure, such as after the operating system has loaded the application code into memory, or optionally even after execution of the relevant corresponding portion of the application program code has started, such as for example after the JAVA virtual machine has loaded the application code into the virtual machine via the “java.lang.ClassLoader.loadClass( )” method and optionally commenced execution.

Persons skilled in the computing arts will be aware of various possible techniques that may be used in the modification of computer code, including but not limited to instrumentation, program transformation, translation, or compilation means and/or methods.

One such technique is to make the modification(s) to the application code, without a preceding or consequential change of the language of the application code. Another such technique is to convert the original code (for example, JAVA language source-code) into an intermediate representation (or intermediate-code language, or pseudo code), such as JAVA byte code. Once this conversion takes place the modification is made to the byte code and then the conversion may be reversed. This gives the desired result of modified JAVA code.

A further possible technique is to convert the application program to machine code, either directly from source-code or via the abovementioned intermediate language or through some other intermediate means. Then the machine code is modified before being loaded and executed. A still further such technique is to convert the original code to an intermediate representation, which is thus modified and subsequently converted into machine code. All such modification routes are envisaged and also a combination of two, three or even more, of such routes.

The DRT 71 or other code modifying means is responsible for creating or replicating a memory structure and contents on each of the individual machines M1, M2 . . . Mn that permits the plurality of machines to interoperate. In some arrangements this replicated memory structure will be identical. Whilst in other arrangements this memory structure will have portions that are identical and other portions that are not. In still other arrangements the memory structures are different only in format or storage conventions such as Big Endian or Little Endian formats or conventions.

These structures and procedures when applied in combination when required, maintain a computing environment where the memory locations, address ranges, objects, classes, assets, resources, or any other procedural or structural aspect of a computer or computing environment are where required created, maintained, operated, and deactivated or deleted in a coordinated, coherent, and consistent manner across the plurality of individual machines M1, M2 . . . Mn.

Therefore the terminology “one”, “single”, and “common” application code or program includes the situation where all machines M1, M2 . . . Mn are operating or executing the same program or code and not different (and unrelated) programs, in other words copies or replicas of same or substantially the same application code are loaded onto each of the interoperating and connected machines or computers.

In conventional arrangements utilising distributed software, memory access from one machine's software to memory physically located on another machine typically takes place via the network interconnecting the machines. Thus, the local memory of each machine is able to be accessed by any other machine and can therefore cannot be said to be independent. However, because the read and/or write memory access to memory physically located on another computer require the use of the slow network interconnecting the computers, in these configurations such memory accesses can result in substantial delays in memory read/write processing operations, potentially of the order of 10⁶-10⁷ cycles of the central processing unit of the machine (given contemporary processor speeds). Ultimately this delay is dependent upon numerous factors, such as for example, the speed, bandwidth, and/or latency of the communication network. This in large part accounts for the diminished performance of the multiple interconnected machines in the prior art arrangement.

However, in the present arrangement all reading of memory locations or data is satisfied locally because a current value of all (or some subset of all) memory locations is stored on the machine carrying out the processing which generates the demand to read memory.

Similarly, all writing of memory locations or data is satisfied locally because a current value of all (or some subset of all) memory locations is stored on the machine carrying out the processing which generates the demand to write to memory.

Such local memory read and write processing operation can typically be satisfied within 10²-10³ cycles of the central processing unit. Thus, in practice there is substantially less waiting for memory accesses which involves and/or writes. Also, the local memory of each machine is not able to be accessed by any other machine and can therefore be said to be independent.

The arrangement is transport, network, and communications path independent, and does not depend on how the communication between machines or DRTs takes place. Even electronic mail (email) exchanges between machines or DRTs may suffice for the communications.

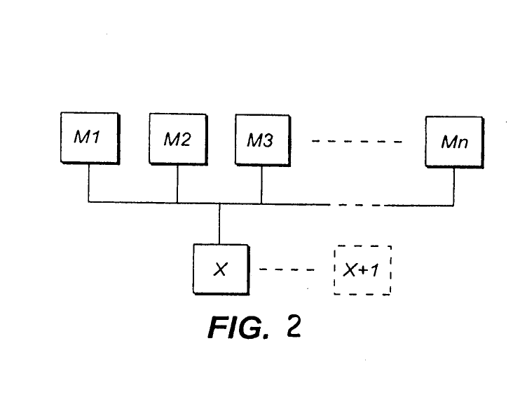

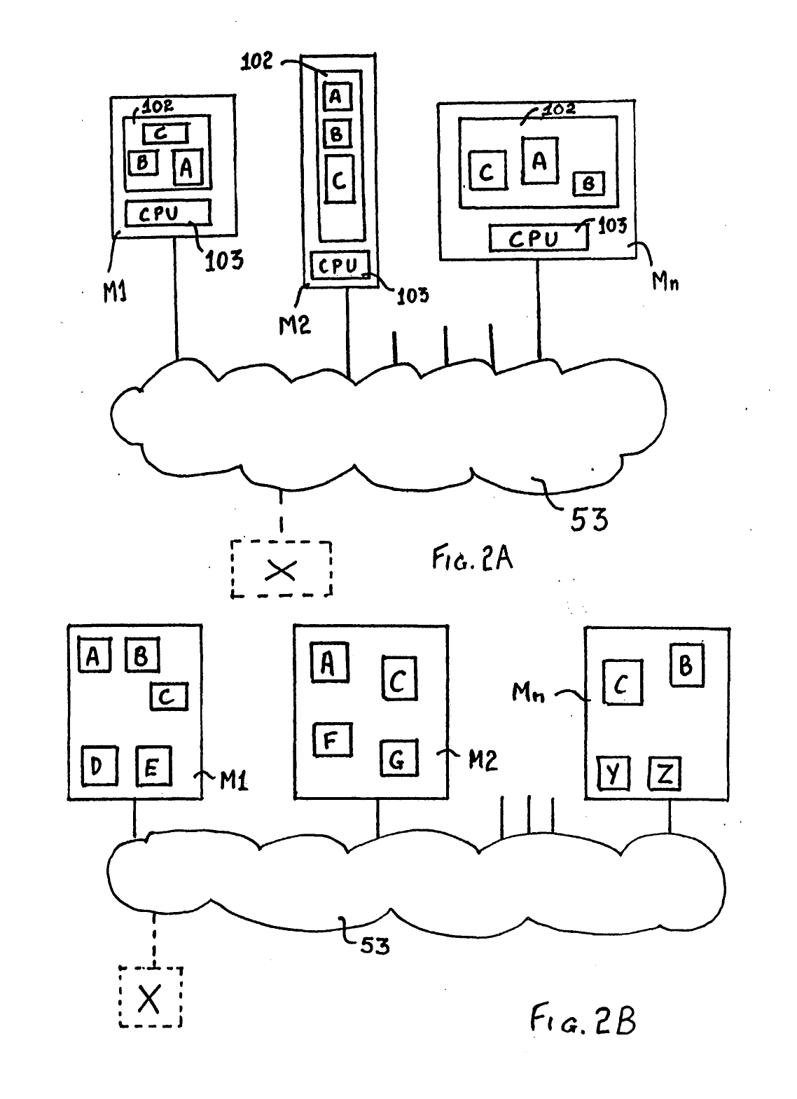

In connection with the above, it will be seen from FIG. 2 that there are a number of machines M1, M2, . . . Mn, “n” being an integer greater than or equal to two, on which the application program 50 of FIG. 1 is being run substantially simultaneously. These machines are allocated a number 1, 2, 3, . . . etc. in a hierarchical order. This order is normally looped or closed so that whilst machines 2 and 3 are hierarchically adjacent, so too are machines “n” and 1. There is preferably a further machine X which is provided to enable various housekeeping functions to be carried out, such as acting as a lock server. In particular, the further machine X can be a low value machine, and much less expensive than the other machines which can have desirable attributes such as processor speed. Furthermore, an additional low value machine (X+1) is preferably available to provide redundancy in case machine X should fail. Where two such server machines X and X+1 are provided, they are preferably, for reasons of simplicity, operated as dual machines in a cluster configuration. Machines X and X+1 could be operated as a multiple computer system in accordance with the abovedescribed arrangements, if desired. However this would result in generally undesirable complexity. If the machine X is not provided then its functions, such as housekeeping functions, are provided by one, or some, or all of the other machines.

In computer programming, it is known to avoid contention by providing a lock on various objects assets or resources such as memory locations. This is normally referred to as “synchronisation”. The above-mentioned International Patent Applications disclose a system in which assets such as corresponding memory locations can be locked to ensure that only one write operation takes place by the computer to its local memory location at any given time, and that all other computers are unable to write to their corresponding memory locations.

Where one particular machine wishes to exclusively use an object, asset or resource (ie a memory location) by means of acquiring a lock on the memory location which is currently being exclusively utilised by another machine, then a queue of waiting machines is created. When the machine exclusively utilising the asset relinquishes the lock over that asset, the first waiting machine in the queue, is then issued with a fresh lock, which enables it to exclusively use the asset and prevents all other machines from exclusively using the asset. If this fresh lock is issued quickly, the first waiting machine may achieve a lock on its corresponding asset before the updating mechanism has had a chance to update the local memory location(s) of the first waiting machine with the revised value(s) generated by the previous machine utilising that asset. If so, the memory structure is not coherent and the calculations performed by the first waiting machine and subsequent to it achieving the lock, may well be flawed.

The data protocol or data format which is used to transmit information between the various machines enables bundles or packets of data to be transmitted or received out of the sequence in which they were created. One way of doing this is to utilize the contention detection, recognition and data format techniques described in International Patent Application No. PCT/AU2007/ . . . entitled “Advanced Contention Detection” (Attorney Reference 5027T-WO) lodged simultaneously herewith and claiming priority of Australian Patent Application No. 2006 905 527 entitled “Advanced Contention Detection” (Attorney reference number 5027T) lodged concurrently with the present application, (and to which U.S. Provisional Patent Application No. 60/850,711 corresponds). The contents of both the above specifications are hereby incorporated in the present specification in full for all purposes.

Briefly stated, the abovementioned data protocol or message format includes both the address of a memory location where a value or content is to be changed, the new value or content, and a count number indicative of the position of the new value or content in a sequence of consecutively sent new values or content.

Thus a sequence of messages are issued from one or more sources. Typically each source is one computer of a multiple computer system and the messages are memory updating messages which include a memory address and a (new or updated) memory content.

Thus each source issues a string or sequence of messages which are arranged in a time sequence of initiation or transmission. The problem arises that the communication network 53 cannot always guarantee that the messages will be received in their order of transmission. Thus a message which is delayed may update a specific memory location with an old or stale content which inadvertently overwrites a fresh or current content.

In order to address this problem each source of messages includes a count value in each message. The count value indicates the position of each message in the sequence of messages issuing from that source. Thus each new message from a source has a count value incremented (preferably by one) relative to the preceding messages. Thus the message recipient is able to both detect out of order messages, and ignore any messages having a count value lower than the last received message from that source. Thus earlier sent but later received messages do not cause stale data to overwrite current data.

As explained in the abovementioned cross referenced specifications, later received packets which are later in sequence than earlier received packets overwrite the content or value of the earlier received packet with the content or value of the later received packet. However, in the event that delays, latency and the like within the network 53 result in a later received packet being one which is earlier in sequence than an earlier received packet, then the content or value of the earlier received packet is not overwritten and the later received packet is effectively discarded. Each receiving computer is able to determine where the latest received packet is in the sequence because of the accompanying count value. Thus if the later received packet has a count value which is greater than the last received packet, then the current content or value is overwritten with the newly received content or value. Conversely, if the newly received packet has a count value which is lower than the existing count value, then the received packet is not used to overwrite the existing value or content. In the event that the count values of both the existing packet and the received packet are identical, then a contention is signalled and this can be resolved.

This resolution requires a machine which is about to propagate a new value for a memory location, and provided that machine is the same machine which generated the previous value for the same memory location, then the count value for the newly generated memory is not increased by one (1) but instead is increased by more than one such as by being increased by two (2) (or by at least two). A fuller explanation is contained in the abovementioned cross referenced provisional PCT specification.

In order to overcome this problem of the possible delay in updating the memory contents of other machines, International Patent Application No. PCT/AU/2006/001445 (WO 2007/041,760) (Attorney Ref. 5027G-WO) which claims priority from Australian Patent Application No. 2005 905 579 entitled “Modified Machine Architecture with Advanced Synchronization” (Attorney Ref: 5027G) lodged 10 Oct. 2005 (and to which U.S. patent application Ser. No. 11/583,961 (60/730,493) corresponds) discloses that at the time the lock is transferred from the previously using machine to the first waiting machine, in addition to transferring the lock (or lock token), the contents of any updated memory location(s) are also transferred to the first waiting machine. The disclosure of these patent specifications is hereby incorporated in the present specification for all purposes. There are several mechanisms or modes, whereby this transfer can take place. Preferably the lock is acquired in respect of the object, asset or resource in respect to which the writing is to take pace, however, this is not absolutely necessary and the lock can be acquired in respect of some other object, asset or resource.

Instead of the abovementioned transfer of the contents or values of all updated memory locations, in accordance with a preferred embodiment of the present invention it is proposed to transfer only the names (or addresses or identifiers) of the updated memory locations together with the current updating count values currently present in the machine which is relinquishing the lock. Thus the machine which is acquiring the lock can check its current updating count values for these memory locations and delay processing until the acquiring machine updating count values are equal to (and preferably greater than by one) the transmitted updating count value of the relinquishing machine.

Two advantages flow from this general arrangement. The first is that the volume of data to be transmitted by the relinquishing machine is reduced. Secondly, if the acquiring machine has already been updated prior to acquiring the lock, then the updating data is not transmitted again as a precaution. Both these advantages result in a lessening of traffic on the network 53.

FIG. 2A is a schematic diagram of a replicated shared memory system. In FIG. 2A three machines are shown, of a total of “n” machines (n being an integer greater than one) that is machines M1, M2, . . . Mn. Additionally, a communications network 53 is shown interconnecting the three machines and a preferable (but optional) server machine X which can also be provided and which is indicated by broken lines. In each of the individual machines, there exists a memory 102 and a CPU 103. In each memory 102 there exist three memory locations, a memory location A, a memory location B, and a memory location C. Each of these three memory locations is replicated in a memory 102 of each machine.

This arrangement of the replicated shared memory system allows a single application program written for, and intended to be run on, a single machine, to be substantially simultaneously executed on a plurality of machines, each with independent local memories, accessible only by the corresponding portion of the application program executing on that machine, and interconnected via the network 53. In International Patent Application No PCT/AU2005/001641 (WO2006/110,937) (Attorney Ref 5027F-D1-WO) to which U.S. patent application Ser. No. 11/259,885 entitled: “Computer Architecture Method of Operation for Multi-Computer Distributed Processing and Co-ordinated Memory and Asset Handling” corresponds, a technique is disclosed to detect modifications or manipulations made to a replicated memory location, such as a write to a replicated memory location A by machine M1 and correspondingly propagate this changed value written by machine M1 to the other machines M2 . . . Mn which each have a local replica of memory location A. This result is achieved by the preferred embodiment of detecting write instructions in the executable object code of the application to be run that write to a replicated memory location, such as memory location A, and modifying the executable object code of the application program, at the point corresponding to each such detected write operation, such that new instructions are inserted to additionally record, mark, tag, or by some such other recording means indicate that the value of the written memory location has changed.

An alternative arrangement is that illustrated in FIG. 2B and termed partial or hybrid replicated shared memory (RSM). Here memory location A is replicated on computers or machines M1 and M2, memory location B is replicated on machines M1 and Mn, and memory location C is replicated on machines M1, M2 and Mn. However, the memory locations D and E are present only on machine M1, the memory locations F and G are present only on machine M2, and the memory locations Y and Z are present only on machine Mn. Such an arrangement is disclosed in Australian Patent Application No. 2005 905 582 Attorney Ref 5027I (to which U.S. patent application Ser. No. 11/583,958 (60/730,543) and PCT/AU2006/001447 (WO2007/041762) correspond). In such a partial or hybrid RSM systems changes made by one computer to memory locations which are not replicated on any other computer do not need to be updated at all. Furthermore, a change made by any one computer to a memory location which is only replicated on some computers of the multiple computer system need only be propagated or updated to those some computers (and not to all other computers).

Consequently, for both RSM and partial RSM, a background thread task or process is able to, at a later stage, propagate the changed value to the other machines which also replicate the written to memory location, such that subject to an update and propagation delay, the memory contents of the written to memory location on all of the machines on which a replica exists, are substantially identical. Various other alternative embodiments are also disclosed in the abovementioned specification.

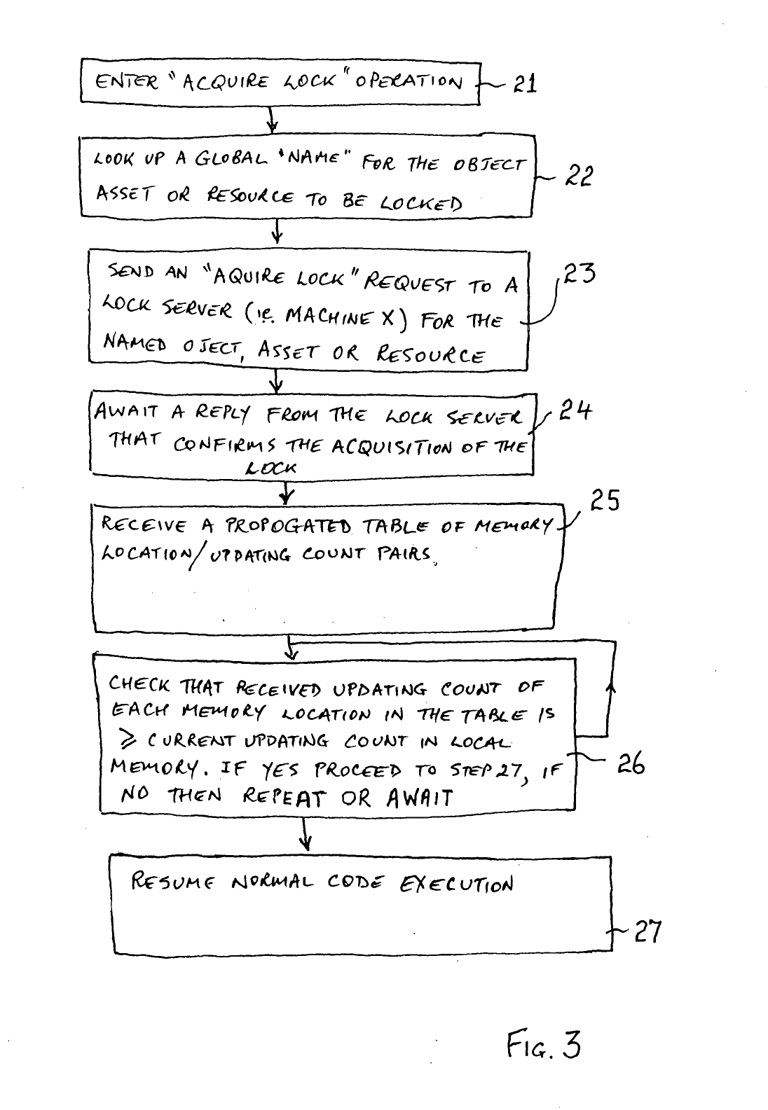

Turning now to FIG. 3, the operation of one of the machines M1-Mn on acquiring a replicated lock is illustrated. Upon entering the “acquire lock” operation, as indicated at step 21, the acquiring machine, say M5, which is to acquire the replicated lock looks up a global name for the replicated object, asset or resource to be locked. For the purposes of this example, it will be assumed that the replicated object asset or resource is an object. However, the replicated object, asset or resource may also be a replicated application memory location/content, or a set of plural replicated application memory locations/contents. Thus at step 22, the global name of the replicated object is looked up, bearing in mind that each of the machines M1-Mn has a local replica object which corresponds to the same replica object in each machine, but which will have the same global name, but possibly a different local name depending upon the organisation of the local application memory of each machine.

Once this global name has been ascertained, machine M5 then sends an “acquire lock” request to the machine X, which functions as the lock server. This is indicated in step 23. As indicated in step 24, machine M5 then awaits a reply from the lock server, which confirms the acquisition of the lock. Alternatively, when a server machine X is not present, or alternatively when it is desired not to use the server machine X as a lock server, then any one or more of the plural machines M1 . . . Mn may perform the operations described herein for server machine X.

For the purposes of explanation, it is convenient to assume that the replicated lock thus acquired is the first replicated lock on the object. As a consequence, machine M5 then proceeds to resume normal code execution. As indicated in step 25, each time a replicated application memory location/content is written to or modified, an entry is made in a table with the identity of the written-to replicated application memory location/content and the associated “count value” (or “updating count” value). As a consequence, when the replicated lock is about to be relinquished, there is in existence a table, which lists the replicated application memory location(s)/content(s), and associated “updating count(s)”/“count value(s)” of each written-to replicated application memory location/content, where an amended content or value was written to a replicated application memory location during operation of the replicated lock. Thus as indicated in step 25, on the acquisition of a replicated lock, each machine receives a table with the global names of the previous written-to replicated application memory locations/contents and associated “updating counts”/“count values” to which the replicated lock relates.

As indicated in step 26, the lock acquiring machine M5 then checks for each replicated application memory location/content identified in the received table that the local/resident “updating count”/“count value” stored in the local memory associated with the corresponding local replica application memory location/content is greater than, or equal to, the “updating count”/“count value” present in the table. If this condition is satisfied, it means that the local replica application memory location(s)/content(s) have been updated in a consistent manner (that is, so as to be consistent with the previous machine(s)) and normal code execution can resume as indicated in step 27.

Alternatively, if this inequality is not satisfied, it means that the local replica application memory locations/contents are stale and must be updated. In one possible arrangement, the check of the local/resident “updating count”/“count value” must be repeated until the inequality is satisfied. That is, step 26 is repeated (a poll activity) until the inequality is satisfied (either as the local/resident “updating count”/“count value” equals the “updating count”/“count value” of the received table). In another arrangement a predetermined time can be allowed to elapse before step 26 is repeated. In a still further arrangement, the replicated lock acquiring computer can simply wait until it receives an updating message from the lock server X updating the relevant replica application memory location(s)/content(s) with the necessary/desired “updating count(s)”/“count value(s)”, in which case the inequality of step 26 is satisfied and step 27 can then be undertaken.

In relation to FIG. 3, the message confirming the acquisition of the lock is normally sent just before sending the propagated table of replica application memory location/content identifiers and “updating count”/“count value” pairs. That is, the message of step 24 is sent before the message of step 25. However, these messages may be received in the reverse order in some circumstances depending upon the nature and load of the network 53, or the transmission order by the sending machine(s). Under these circumstances steps 25 and 26 can commence prior to step 24 commencing, but step 27 does not commence until after all steps 24, 25 and 26 are completed.

Clearly, if the “updating count”/“count value” in the local memory equals the “updating count”/“count value” in the received table, then this means that the contents or value of the given local/resident replica application memory location/content in the lock relinquishing and lock acquiring machines are the same. Alternatively, if the “updating count”/“count value” in the local memory exceeds that in the received table, this means that further updating of the local/resident replica application memory location/content has occurred since the lock was relinquished and consequently the local/resident replica application memory location(s)/content(s) are “newer” than that indicated in the received table. As a result, such “newer” local replica application memory location(s)/content(s) satisfy the condition of step 26.

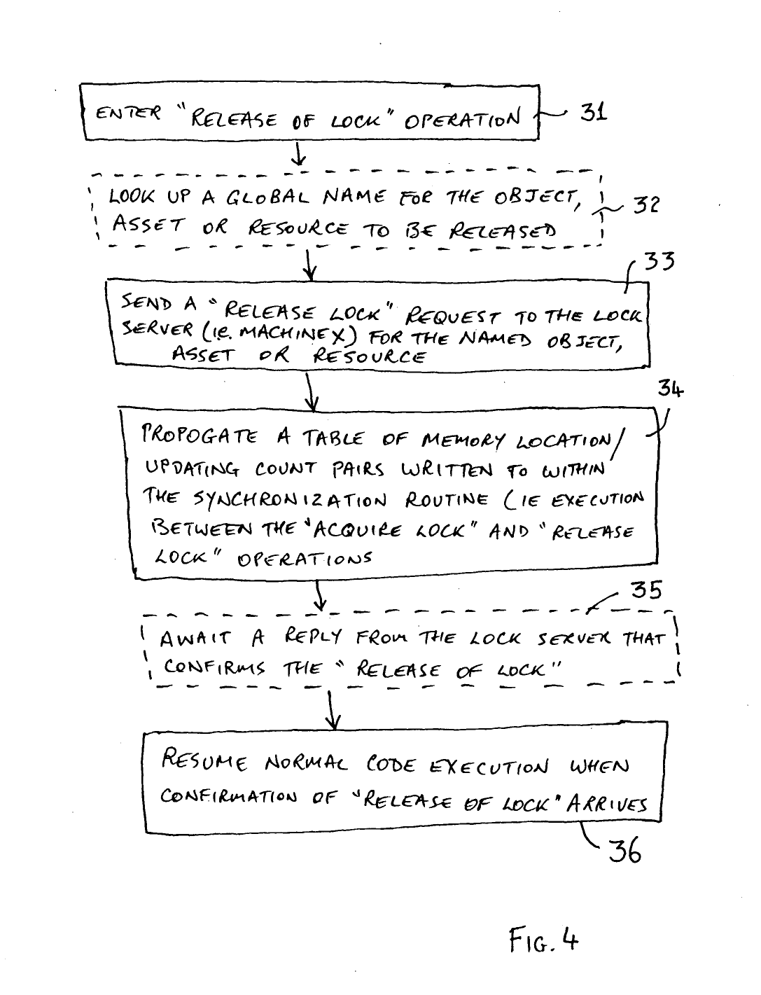

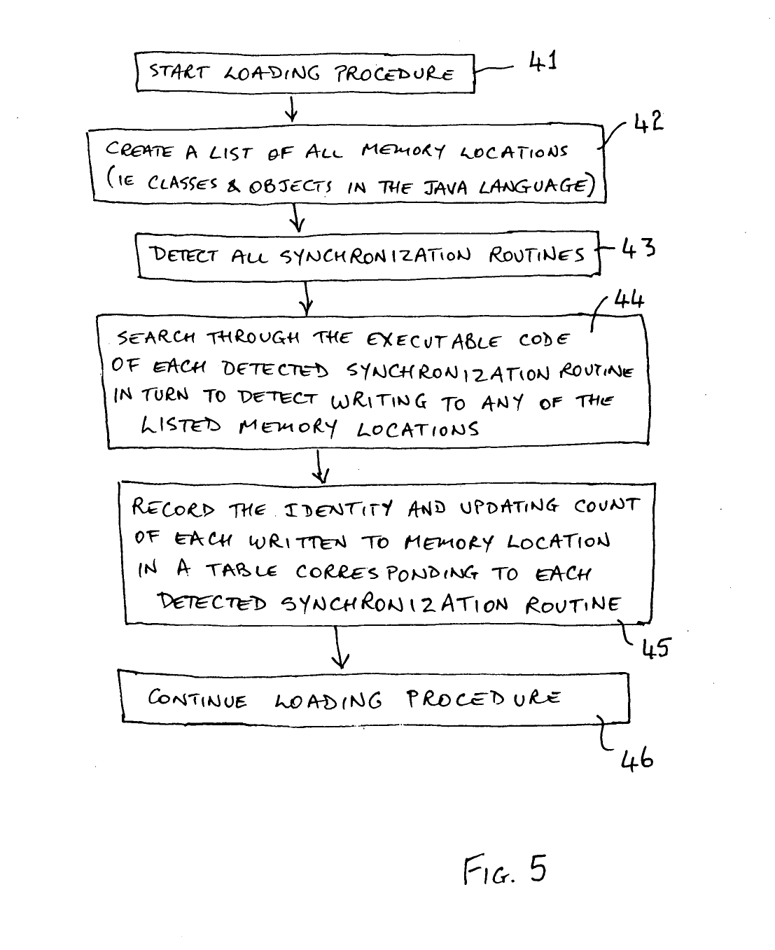

Similarly, as indicated in FIG. 4, where a replicated lock is intended to be released or relinquished, as indicated at step 31 then the relinquishing machine, M10, preferably checks to determine the global name of the replicated object (or other replicated asset, resource, memory location/content, or plural memory locations/contents) to be unlocked. This is indicated at step, 32. Next the relinquishing machine, M10 sends a “release lock” request to the lock server machine X and this is indicated at step 33. The lock server machine X sends to the requesting machine M5, not only the lock token or lock permission, but also propagates the previously generated table of identified replicated application memory locations/contents identifiers and “updating count”/“count value” pairs created whilst the lock was held by machine M10. Preferably as indicated at step 35, the machine M10 awaits a reply from a lock server, which confirms the release of the lock. This step is a preferable one, but not essential. Next, as indicated at step 36, the relinquishing machine M10 resumes normal code execution.

The above-mentioned procedure for replicated lock acquisition and release, can be modified so as to reduce the volume of data/material contained within the table to be propagated from one machine to the other. In particular, the above mentioned procedure suffers from the disadvantage that where a specific replicated application memory location/content is written to on many occasions, multiple “updating count”/“count value” may be stored/recorded within the table, but only the final “updating count”/“count value” is of interest to the next waiting machine (that is, the next machine to acquire the same replicated lock). In order to reduce the volume of data/material sent with each table, the above-mentioned procedure can be modified by noting only the names/identities of the various replica application memory locations/contents which had been written to, during the operation of the lock. Only subsequently at the relinquishing of the replicated lock (or other point corresponding to the end of the lock operation(s)), is the current value of each “updating count”/“count value” for each written-to replicated application memory location/content read and then inserted into the table.

Irrespective of which method is used, preferably the lock token/permission and the accompanying table of replica application memory location/content identifiers and “updating count”/“count value” pairs are given top priority for transmission via the communications network 53. As a consequence, the first waiting machine in the queue of waiting machines to acquire the same replicated lock receives not only be lock token/permission, but also the global names/identities of the relevant written0to replica application memory locations/contents, together with their associated “up-to-date” “updating counts”/“count values”.

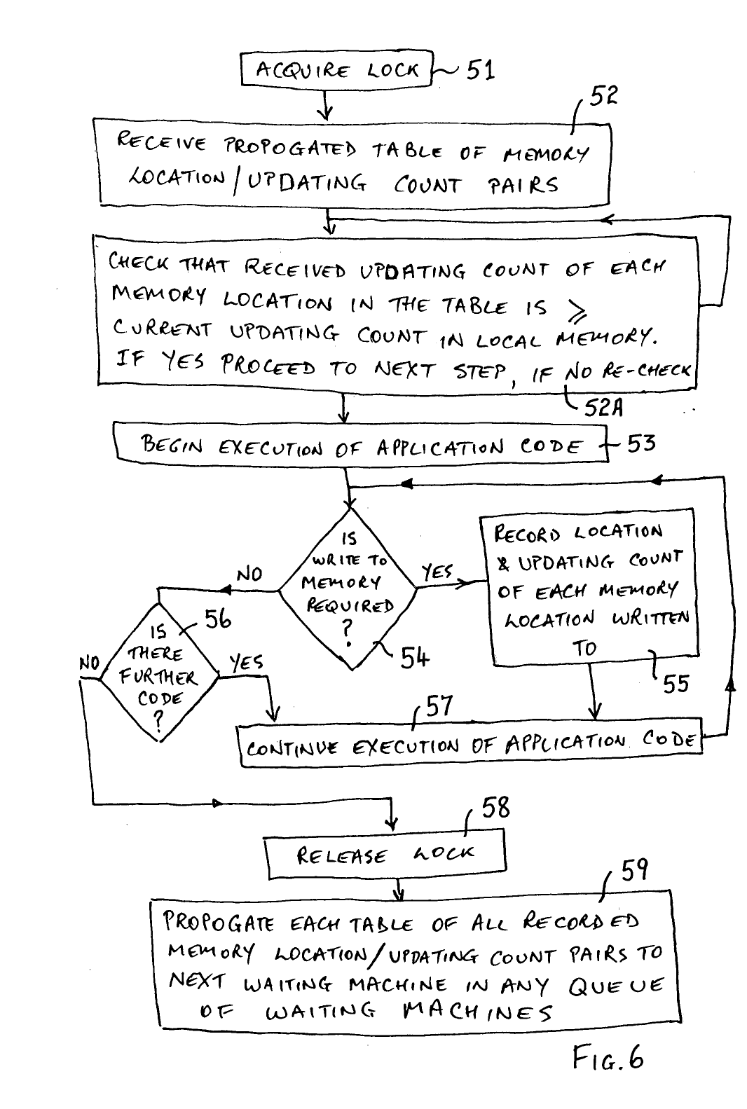

An alternative arrangement is illustrated in FIGS. 5 and 6. Here, during the initial loading of the application program, after commencing the loading procedure at step 41, step 42 is preferably carried out so as to create a list of all application memory locations/contents and/or replicated application memory locations/contents to be utilised by the application program during operation/execution. Importantly, step 42 is an optional step, and therefore may be omitted in alternative arrangements. Next, as indicated in step 43, a search of the program is conducted in order to detect all synchronisation routines or mutual exclusion routines or operations or the like. Then, as indicated in step 44, for each detected synchronisation routine, a search is made to detect any listed replicated application memory locations/contents which are to be written to. Alternatively, when step 42 has been omitted and a list of application memory locations/contents and/or replicated application memory locations/contents has not been generated, then at step 44, a search is made to detect any replicated application memory locations/contents which are to be written to.

In step 45, a table is created in which is recorded the identity of each replicated application memory location/content detected to be written to at step 44. In a further alternative embodiment of step 45, the application program code of the synchronization routine or mutual exclusion routine or the like detected at step 43 and 44, may be instrumented or modified by the insertion of additional instructions and/or operations to perform or carry out the operation of step 45. In such an alternative embodiment as this, the inserting of instructions and/or operations occurs in place of step 45 of FIG. 5, and the inserted instructions and/or operations operate to record the identity and “updating count”/“count value” of each written-to replicated application memory location/content in a table corresponding to the modified synchronization routine. Once this procedure has been completed in step 45, the loading procedure continues as indicated at step 46, whereby the modified application program code generated by the preceding steps 41-45 is loaded in place of the original/unmodified application program code commenced to be loaded at step 41.

In FIG. 6, the procedure of acquiring and relinquishing a replicated lock, where the above-mentioned modification of the program has been carried out at loading, is illustrated. As indicated at step 51, once the replicated lock is acquired, the machine acquiring the replicated lock also receives the propagated table of replica application memory location/content identifiers and “updating count”/“count value” pairs. In order to ensure that the identified local replica application memory location(s)/content(s) corresponding to the received table of step 52 have the latest contents (which may include instructions) and/or values (which may be for example numbers or numeric values), the machine acquiring the replicated lock checks that the corresponding local replica application memory location(s)/content(s) are consistent (that is, “up-to-date”). The machine which has acquired the replicated lock then checks (as before) at step 52A to ensure that the local/resident “updating count”/“count value” corresponding to each identified replicated application memory location/content is greater than or equal to the received tabulated “updating count(s)”/“count value(s)” of step 52. If so, the machine acquiring the replicated lock is thus in a position to begin execution of the application program code with the identified local replica application memory location(s)/content(s) which are assured of having been consistently updated. Thereafter, execution of the application synchronization routine or mutual exclusion routine or the like may proceed, and this is indicated at step 53.

During the execution of the application code, as indicated by step 54, if any write to a replicated application memory location/content is required, then the identity of the written-to replicated application memory location/content and the associated “updating count”/“count value” of each written-to replicated application memory location/content written to, is recorded in the received table. Once this has been done, as indicated at step 56, if there is no further application program code to be executed as part of the application synchronization routine commenced at step 53, then the replicated lock is released as indicated at step 58. As indicated by step 59, at the release of the replicated lock, the table generated at step 55 is propagated to the next machine to acquire the same replicated lock, the table containing all recorded replica application memory location/content identities and “updating count”/“count value” pairs for any replicated application memory location/content written-to during the operation of the lock or synchronization routine or mutual exclusion routine or the like.

In all of the above described arrangements and embodiments, an “updating count”/“count value” is described as associated with each replicated application memory-location/content. Specifically, the described tables of step 26 of FIG. 3, step 34 of FIG. 4, step 45 of FIG. 5, and step 55 of FIG. 6, comprise one or more identities of written-to replicated application memory locations/contents, and one or more associated “updating counts”/“count values”. Additionally disclosed in step 26 of FIG. 3, and step 52A of FIG. 5, are rules by which a received table containing identities of written-to replicated application memory locations/contents and associated “updating counts”/“count values”, is used to ensure that the corresponding local/resident replica application memory locations/contents have been consistently updated prior to commencing execution of the application synchronization routine or the like.

In further alternative arrangements and embodiments, a “resolution value” may also be associated with each replicated application memory location/content, and furthermore, one or more “resolution values” may additionally be recorded and/or stored in the abovementioned tables, and used to further ensure that the corresponding local/resident replica application memory locations/contents have been consistently updated prior to commencing execution of the application synchronization routine or the like. Specifically, when one or more “resolution values” are recorded or stored in the abovementioned tables (or alternatively, accompany or are associated with the abovementioned tables), then such abovedescribed rules for comparing local/resident “updating counts”/“count values” with the corresponding received “updating counts”/“count values” of a received table, are expanded to include a comparison between local/resident “resolution values” and the corresponding received “resolution value(s)” of the received table. When such expanded rules are employed, then only when it has been determined that the local/resident “updating counts”/“count values” are equal to or greater than the corresponding “updating counts”/“count values” of the received table, and also that the local/resident “resolution values” are equal to the corresponding “resolution value(s)” of the received table, may the receiving machine be deemed to have been consistently updated and therefore the application synchronization routine or the like may be permitted to proceed. Further details are disclosed in the abovementioned cross-referenced PCT application (Attorney Ref. 5027T-WO)

Preferably all lock described herein are application locks, or other replicated locks associated with the application program. Further preferably, all replicated locks described herein are replicated application locks, or other replicated locks associated with the application program.

The use of the term “replicated locks” is to be understood to mean a lock operation (or other mutual exclusion operation) by a single machine of a multiple computer system operating as a replicated shared memory arrangement, where such lock operation corresponds to a replicated object, memory location, asset, or other replicated resource of the multiple machines.

Preferably, all “updating counts”/“count values” stored or recoded in a transmitted table or the like as described above, are incremented “updating counts”/“count values”.

The foregoing describes only some embodiments of the present invention and modifications, obvious to those skilled in the art, can be made thereto without departing from the scope of the present invention. For example, reference to JAVA includes both the JAVA language and also JAVA platform and architecture.

In all described instances of modification, where the application code 50 is modified before, or during loading, or even after loading but before execution of the unmodified application code has commenced, it is to be understood that the modified application code is loaded in place of, and executed in place of, the unmodified application code subsequently to the modifications being performed.

Alternatively, in the instances where modification takes place after loading and after execution of the unmodified application code has commenced, it is to be understood that the unmodified application code may either be replaced with the modified application code in whole, corresponding to the modifications being performed, or alternatively, the unmodified application code may be replaced in part or incrementally as the modifications are performed incrementally on the executing unmodified application code. Regardless of which such modification routes are used, the modifications subsequent to being performed execute in place of the unmodified application code.

It is advantageous to use a global identifier is as a form of ‘meta-name’ or ‘meta-identity’ for all the similar equivalent local objects (or classes, or assets or resources or the like) on each one of the plurality of machines M1, M2 . . . Mn. For example, rather than having to keep track of each unique local name or identity of each similar equivalent local object on each machine of the plurality of similar equivalent objects, one may instead define or use a global name corresponding to the plurality of similar equivalent objects on each machine (e.g. “globalname7787”), and with the understanding that each machine relates the global name to a specific local name or object (e.g. “globalname7787” corresponds to object “localobject456” on machine M1, and “globalname7787” corresponds to object “localobject885” on machine M2, and “globalname7787” corresponds to object “localobject111” on machine M3, and so forth).

It will also be apparent to those skilled in the art in light of the detailed description provided herein that in a table or list or other data structure created by each DRT 71 when initially recording or creating the list of all, or some subset of all objects (e.g. memory locations or fields), for each such recorded object on each machine M1, M2 . . . Mn there is a name or identity which is common or similar on each of the machines M1, M2 . . . Mn. However, in the individual machines the local object corresponding to a given name or identity will or may vary over time since each machine may, and generally will, store memory values or contents at different memory locations according to its own internal processes. Thus the table, or list, or other data structure in each of the DRTs will have, in general, different local memory locations corresponding to a single memory name or identity, but each global “memory name” or identity will have the same “memory value or content” stored in the different local memory locations. So for each global name there will be a family of corresponding independent local memory locations with one family member in each of the computers. Although the local memory name may differ, the asset, object, location etc has essentially the same content or value. So the family is coherent.

The term “table” or “tabulation” as used herein is intended to embrace any list or organised data structure of whatever format and within which data can be stored and read out in an ordered fashion.

It will also be apparent to those skilled in the art in light of the description provided herein that the abovementioned modification of the application program code 50 during loading can be accomplished in many ways or by a variety of means. These ways or means include, but are not limited to at least the following five ways and variations or combinations of these five, including by:
(i) re-compilation at loading,
(ii) a pre-compilation procedure prior to loading,
(iii) compilation prior to loading,
(iv) “just-in-time” compilation(s), or
(v) re-compilation after loading (but, for example, before execution of the relevant or corresponding application code in a distributed environment).

Traditionally the term “compilation” implies a change in code or language, for example, from source to object code or one language to another. Clearly the use of the term “compilation” (and its grammatical equivalents) in the present specification is not so restricted and can also include or embrace modifications within the same code or language.

Given the fundamental concept of modifying memory manipulation operations to coordinate operation between and amongst a plurality of machines M1, M2 . . . Mn, there are several different ways in which this coordinated, coherent and consistent memory state and manipulation operation concept, method, and procedure may be carried out or implemented.

In the first way, a particular machine, say machine M2, loads the asset (such as class or object) inclusive of memory manipulation operation(s), modifies it, and then loads each of the other machines M1, M3 . . . Mn (either sequentially or simultaneously or according to any other order, routine or procedure) with the modified object (or class or other assert or resource) inclusive of the new modified memory manipulation operation. Note that there may be one or a plurality of memory manipulation operations corresponding to only one object in the application code, or there may be a plurality of memory manipulation operations corresponding to a plurality of objects in the application code. Note that in one way, the memory manipulation operation(s) that is (are) loaded is executable intermediary code.

In this arrangement, which may be termed “master/slave” each of the slave (or secondary) machines M1, M3 . . . Mn loads the modified object (or class), and inclusive of the new modified memory manipulation operation(s), that was sent to it over the computer communications network or other communications link or path by the master (or primary) machine, such as machine M2, or some other machine as a machine X. In a slight variation of this “master/slave” or “primary/secondary” arrangement, the computer communications network can be replaced by a shared storage device such as a shared file system, or a shared document/file repository such as a shared database.

It will be appreciated in the light of the detailed description provided herein that the modification performed on each machine or computer need not and frequently will not be the same or identical. What is required is that they are modified in a similar enough way that each of the plurality of machines behaves consistently and coherently relative to the other machines. Furthermore, it will be appreciated that there are a myriad of ways to implement the modifications that may for example depend on the particular hardware, architecture, operating system, application program code, or the like or different factors. It will also be appreciated that implementation can be within an operating system, outside of or without the benefit of any operating system, inside the virtual machine, in an EPROM, in software, in hardware, in firmware, or in any combination of these.

In a still further arrangement each machine M1, M2 . . . Mn receives the unmodified asset (such as class or object) inclusive of one or more memory manipulation operation(s), but modifies the operations and then loads the asset (such as class or object) consisting of the now modified operations. Although one machine, such as the master or primary machine may customize or perform a different modification to the memory manipulation operation(s) sent to each machine, this arrangement more readily enables the modification carried out by each machine to be slightly different. It can thereby be enhanced, customized, and/or optimized based upon its particular machine architecture, hardware processor, memory, configuration, operating system, or other factors yet still be similar, coherent and consistent with the other machines and with all other similar modifications.

In all of the described instances or embodiments, the supply or the communication of the asset code (such as class code or object code) to the machines M1, M2 . . . Mn and optionally inclusive of a machine X, can be branched, distributed or communication among and between the different machines in any combination or permutation; such as by providing direct machine to machine communication (for example, M2 supplies each of M1, M3, M4 etc. directly), or by providing or using cascaded or sequential communication (for example, M2 supplies M1 which then supplies M3 which then supplies M4, and so on) or a combination of the direct and cascaded and/or sequential.

The abovedescribed arrangement needs to be varied in the situation where the modification relates to a cleanup routine, finalization or similar, which is only to be carried out by one of the plurality of computers In this variation of this “master/slave” or “primary/secondary” arrangement, machine M2 loads the asset (such as class or object) inclusive of a cleanup routine in unmodified form on machine M2, and then (for example, M2 or each local machine) deletes the unmodified cleanup routine that had been present on the machine in whole or part from the asset (such as class or object) and loads by means of the computer communications network the modified code for the asset with the now modified or deleted cleanup routine on the other machines. Thus in this instance the modification is not a transformation, instrumentation, translation or compilation of the asset cleanup routine but a deletion of the cleanup routine on all machines except one. In one arrangement the actual code-block of the finalization or cleanup routine is deleted on all machines except one, and this last machine therefore is the only machine that can execute the finalization routine because all other machines have deleted the finalization routine. One benefit of this approach is that no conflict arises between multiple machines executing the same finalization routine because only one machine has the routine.

The process of deleting the cleanup routine in its entirety can either be performed by the “master” machine (such as for example machine M2 or some other machine such as machine X) or alternatively by each other machine M1, M3 . . . Mn upon receipt of the unmodified asset. An additional variation of this “master/slave” or “primary/secondary” arrangement is to use a shared storage device such as a shared file system, or a shared document/file repository such as a shared database as means of exchanging the code for the asset, class or object between machines M1, M2 . . . Mn and optionally the server machine X.

In a further arrangement, a particular machine, say for example machine M1, loads the unmodified asset (such as class or object) inclusive of a finalization or cleanup routine and all the other machines M2, M3 . . . Mn perform a modification to delete the cleanup routine of the asset (such as class or object) and load the modified version.

In a still further arrangement, the machines M1, M2 . . . Mn, may send some or all load requests to the additional server machine X, which performs the modification to the application program code 50 (including or consisting of assets, and/or classes, and/or objects) and inclusive of finalization or cleanup routine(s), via any of the abovementioned methods, and returns in the modified application program code inclusive of the now modified finalization or cleanup routine(s) to each of the machines M1 to Mn, and these machines in turn load the modified application program code inclusive of the modified routine(s) locally. In this arrangement, machines M1 to Mn forward all load requests to machine X, which returns a modified application program code inclusive of modified finalization or cleanup routine(s) to each machine. The modifications performed by machine X can include any of the modifications described. This arrangement may of course be applied to some only of the machines whilst other arrangements described herein are applied to others of the machines.

Those skilled in the computer and/or programming arts will be aware that when additional code or instructions is/are inserted into an existing code or instruction set to modify same, the existing code or instruction set may well require further modification (such as for example, by re-numbering of sequential instructions) so that offsets, branching, attributes, mark up and the like are properly handled or catered for.

Similarly, in the JAVA language memory locations include, for example, both fields and array types. The above description deals with fields and the changes required for array types are essentially the same mutatis mutandis. Also the present invention is equally applicable to similar programming languages (including procedural, declarative and object orientated languages) to JAVA including Microsoft.NET platform and architecture (Visual Basic, Visual C/C++, and C#) FORTRAN, C/C++, COBOL, BASIC etc.

The terms object and class used herein are derived from the JAVA environment and are intended to embrace similar terms derived from different environments such as dynamically linked libraries (DLL), or object code packages, or function unit or memory locations.

Various means are described relative to embodiments of the invention, including for example but not limited to lock means, distributed run time means, modifier or modifying means, and the like. In at least one arrangement of the invention, any one or each of these various means may be implemented by computer program code statements or instructions (including by a plurality of computer program code statements or instructions) that execute within computer logic circuits, processors, ASICs, logic or electronic circuit hardware, microprocessors, microcontrollers or other logic to modify the operation of such logic or circuits to accomplish the recited operation or function. In another arrangement, any one or each of these various means may be implemented in firmware and in other arrangements such may be implemented in hardware. Furthermore, any one or each of these various means may be implemented by a combination of computer program software, firmware, and/or hardware.

Any and each of the abovedescribed methods, procedures, and/or routines may advantageously be implemented as a computer program and/or computer program product stored on any tangible media or existing in electronic, signal, or digital form. Such computer program or computer program products comprising instructions separately and/or organized as modules, programs, subroutines, or in any other way for execution in processing logic such as in a processor or microprocessor of a computer, computing machine, or information appliance; the computer program or computer program products modifying the operation of the computer in which it executes or on a computer coupled with, connected to, or otherwise in signal communications with the computer on which the computer program or computer program product is present or executing. Such a computer program or computer program product modifies the operation and architectural structure of the computer, computing machine, and/or information appliance to alter the technical operation of the computer and realize the technical effects described herein.

The invention may be constituted by a computer program product comprising a set of program instructions stored in a storage medium or existing electronically in any form and operable to permit a plurality of computers to carry out any of the methods, procedures, routines, or the like as described herein including in any of the claims.

Furthermore, the invention includes (but is not limited to) a plurality of computers, or a single computer adapted to interact with a plurality of computers, interconnected via a communication network or other communications link or path and each operable to substantially simultaneously or concurrently execute the same or a different portion of an application code written to operate on only a single computer on a corresponding different one of computers. The computers are programmed to carry out any of the methods, procedures, or routines described in the specification or set forth in any of the claims, on being loaded with a computer program product or upon subsequent instruction. Similarly, the invention also includes within its scope a single computer arranged to co-operate with like, or substantially similar, computers to form a multiple computer system

It is to be noted that the abovedescribed use of the term “table” is intended to include within its scope any temporary data structures, temporary data stores, temporary buffer memories, temporary record stores, temporary record memories, or such similar record or data structure or record or data store means to be used (preferably temporarily) in the operation of the steps of this invention to store or record the identities and the like of written-to replicated application memory locations/contents. Specifically, such tables or other temporary data structures may be created during the loading process of the application program, however it is not a requirement that such temporary structures be created during load time or modification time. Alternatively, such tables or temporary data structures (or temporary data stores, temporary buffer memories, temporary record stores, temporary record memories, or such similar record or data structure or record or data store means) may be created during the runtime of the application program. When such runtime generation arrangement is to be used, the executable object code is modified as described in this specification during loading (or some anticipated other time) in order to insert into the application's executable code the necessary instructions and/or operations to create such a table or temporary data structure (or temporary data store, temporary buffer memory . . . etc) when the modified executable object code is ultimately loaded into the computing system, software platform, or language and execution of that modified application code has commenced.

Therefore in such a runtime arrangement, the steps outlined in this specification for the creation of a tables or other temporary data structure and the instructions and/or operations which create such temporary data structure are inserted into the executable object code in such a manner that they will execute when the executable object code of the application is itself executed in order to create, generated, allocate, return, access, or otherwise make available such a table or other temporary data structure (or temporary data store, temporary buffer memory, temporary record store, temporary record memory, or such similar record or data structure or record or data store means).

The terms “application program code”, “program code”, “executable code”, “object-code”, “code-sequence”, “instruction sequence”, “operation sequence”, and other such similar terms used herein are to be understood to include any sequence of two or more codes, instructions, operations, or similar. Importantly, such terms are not to be restricted to formal bodies of associated code or instructions or operations, such as methods, procedures, functions, routines, subroutines or similar, and instead such terms above may include within their scope any subset or excerpt or other partial arrangement of such formal bodies of associated code or instructions or operations, Alternatively, the above terms may also include or encompass the entirety of such formal bodies of associated code or instructions or operations.

It will also be known to those skilled in the computing arts that when searching the executable code (or other application program code) to detect synchronization routines, or write operations, other operations, or more generally any other instructions or operations, that it may be necessary not to search through the code in the order that it is stored in its compiled form, but rather to search through the code in accordance with various alternative control flow paths such as conditional and unconditional branches. Therefore in the determination that one operation precedes another, it is to be understood that the two operations may not appear chronologically or sequentially in the compiled object code, but rather that a first operation may appear later in the compiled code representation than a second operation but when such code is executed in accordance with the control-flow paths contained therein, the “first” operation will take place or precede the execution of the “second” operation.

With reference to FIG. 5, at step 46 the loading procedure of the software platform, computer system or language is continued, resumed or commenced with the understanding that the loading procedure continued, commenced, or resumed at step 46 does so utilising the modified executable code (or other modified application program code) that has been modified and not the original unmodified application executable code originally with which the loading procedure commenced at step 41.

The term “distributed runtime system”, “distributed runtime”, or “DRT” and such similar terms used herein are intended to capture or include within their scope any application support system (potentially of hardware, or firmware, or software, or combination and potentially comprising code, or data, or operations or combination) to facilitate, enable, and/or otherwise support the operation of an application program written for a single machine (e.g. written for a single logical shared-memory machine) to instead operate on a multiple computer system with independent local memories and operating in a replicated shared memory arrangement. Such DRT or other “application support software” may take many forms, including being either partially or completely implemented in hardware, firmware, software, or various combinations therein.

The methods of this invention described herein are preferably implemented in such an application support system, such as DRT described in International Patent Application No. PCT/AU2005/000580 published under WO 2005/103926 (and to which US Patent Application No. 111/111,946 Attorney Code 5027F-US corresponds), however this is not a requirement of this invention. Alternatively, an implementation of the methods of this invention may comprise a functional or effective application support system (such as a DRT described in the abovementioned PCT specification) either in isolation, or in combination with other softwares, hardwares, firmwares, or other methods of any of the above incorporated specifications, or combinations therein.

The reader is directed to the abovementioned PCT specification for a full description, explanation and examples of a distributed runtime system (DRT) generally, and more specifically a distributed runtime system for the modification of application program code suitable for operation on a multiple computer system with independent local memories functioning as a replicated shared memory arrangement, and the subsequent operation of such modified application program code on such multiple computer system with independent local memories operating as a replicated shared memory arrangement.

Also, the reader is directed to the abovementioned PCT specification for further explanation, examples, and description of various methods and means which may be used to modify application program code during loading or at other times.

Also, the reader is directed to the abovementioned PCT specification for further explanation, examples, and description of various methods and means which may be used to modify application program code suitable for operation on a multiple computer system with independent local memories and operating as a replicated shared memory arrangement.

Finally, the reader is directed to the abovementioned PCT specification for further explanation, examples, and description of various methods and means which may be used to operate replicated memories of a replicated shared memory arrangement, such as updating of replicated memories when one of such replicated memories is written-to or modified.

Furthermore, it will be appreciated by those skilled in the computing arts that the act of inserting instructions into a compiled object code sequence (or other code or instruction or operation sequence) may need to take into account various instruction and code offsets that are used in or by the object code or other code-sequence and that will or may be altered by the insertion of new instructions into the object code or other code-sequence. For example, it may be necessary in the instance where instructions or operations are inserted at a point corresponding to some other instruction(s) or operation(s), that any branches, paths, jumps, or branch offsets or similar that span the location(s) of the inserted instructions or operations may need to be updated to account for these additionally inserted instructions or operations.

Such processes of realigning branch offsets, attribute offsets or other code offsets, pointers or values (whether within the code, or external to the code or instruction sequence but which refer to specific instructions or operations contained within such code or instruction sequence) may be required or desirable, and such requirements will be known to those skilled in the computing arts and able to be realized by such persons skilled in the computing arts.

In alternative multicomputer arrangements, such as distributed shared memory arrangements and more general distributed computing arrangements, the above described methods may still be applicable, advantageous, and used. Specifically, any multi-computer arrangement where replica, “replica-like”, duplicate, mirror, cached or copied memory locations exist, such as any multiple computer arrangement where memory locations (singular or plural), objects, classes, libraries, packages etc are resident on a plurality of connected machines and preferably updated to remain consistent, then the above methods apply. For example, distributed computing arrangements of a plurality of machines (such as distributed shared memory arrangements) with cached memory locations resident on two or more machines and optionally updated to remain consistent comprise a functional “replicated memory system” with regard to such cached memory locations, and is to be included within the scope of the present invention. Thus, it is to be understood that the aforementioned methods apply to such alternative multiple computer arrangements. The above disclosed methods may be applied in such “functional replicated memory systems” (such as distributed shared memory systems with caches) mutatis mutandis.

It is also provided and envisaged that any of the described functions or operations described as being performed by an optional server machine X (or multiple optional server machines) may instead be performed by any one or more than one of the other participating machines of the plurality (such as machines M1, M2, M3 . . . Mn of FIG. 2).

Alternatively or in combination, it is also further provided and envisaged that any of the described functions or operations described as being performed by an optional server machine X (or multiple optional server machines) may instead be partially performed by (for example broken up amongst) any one or more of the other participating machines of the plurality, such that the plurality of machines taken together accomplish the described functions or operations described as being performed by an optional machine X. For example, the described functions or operations described as being performed by an optional server machine X may broken up amongst one or more of the participating machines of the plurality.

Further alternatively or in combination, it is also further provided and envisaged that any of the described functions or operations described as being performed by an optional server machine X (or multiple optional server m0achines) may instead be performed or accomplished by a combination of an optional server machine X (or multiple optional server machines) and any one or more of the other participating machines of the plurality (such as machines M1, M2, M3 . . . Mn), such that the plurality of machines and optional server machines taken together accomplish the described functions or operations described as being performed by an optional single machine X. For example, the described functions or operations described as being performed by an optional server machine X may broken up amongst one or more of an optional server machine X and one or more of the participating machines of the plurality.

Various record storage and transmission arrangements may be used when implementing this invention. One such record or data storage and transmission arrangement is to use “tables”, or other similar data storage structures. Regardless of the specific record or data storage and transmission arrangements used, what is important is that the replicated written-to memory locations are able to be identified, and their updated values (and identity) are to be transmitted to other machines (preferably machines of which a local replica of the written-to memory locations reside) so as to allow the receiving machines to store the received updated memory values to the corresponding local replica memory locations.

Thus, the above methods are not to be restricted to any of the specific described record or data storage or transmission arrangements, but rather any record or data storage or transmission arrangement which is able to accomplish the methods may be used.

Specifically with reference to the described example of a “table”, the use of a “table” storage or transmission arrangement (and the use of the term “table” generally) is illustrative only and to be understood to include within its scope any comparable or functionally equivalent record or data storage or transmission means or method, such as may be used to implement the methods of this invention.

The terms “object” and “class” used herein are derived from the JAVA environment and are intended to embrace similar terms derived from different environments, such as modules, components, packages, structs, libraries, and the like.

The use of the term “object” and “class” used herein is intended to embrace any association of one or more memory locations. Specifically for example, the term “object” and “class” is intended to include within its scope any association of plural memory locations, such as a related set of memory locations (such as, one or more memory locations comprising an array data structure, one or more memory locations comprising a struct, one or more memory locations comprising a related set of variables, or the like).

Reference to JAVA in the above description and Figs. includes, together or independently, the JAVA language, the JAVA platform, the JAVA architecture, and the JAVA virtual machine. Additionally, the present invention is equally applicable mutatis mutandis to other non-JAVA computer languages (including for example, but not limited to any one or more of, programming languages, source-code languages, intermediate-code languages, object-code languages, machine-code languages, assembly-code languages, or any other code languages), machines (including for example, but not limited to any one or more of, virtual machines, abstract machines, real machines, and the like), computer architectures (possible including for example, but not limited to any one or more of, real computer/machine architectures, or virtual computer/machine architectures, or abstract computer/machine architectures, or microarchitectures, or instruction set architectures, or the like), or platforms (including for example, but not limited to any one or more of, computer/computing platforms, or operating systems, or programming languages, or runtime libraries, or the like).

Examples of such programming languages include procedural programming languages, or declarative programming languages, or object-oriented programming languages. Further examples of such programming languages include the Microsoft.NET language(s) (such as Visual BASIC, Visual BASIC.NET, Visual C/C++, Visual C/C++.NET, C#, C#.NET, etc), FORTRAN, C/C++, Objective C, COBOL, BASIC, Ruby, Python, etc.

Examples of such machines include the JAVA Virtual Machine, the Microsoft .NET CLR, virtual machine monitors, hypervisors, VMWare, Xen, and the like.

Examples of such computer architectures include, Intel Corporation's x86 computer architecture and instruction set architecture, Intel Corporation's NetBurst microarchitecture, Intel Corporation's Core microarchitecture, Sun Microsystems' SPARC computer architecture and instruction set architecture, Sun Microsystems' UltraSPARC III microarchitecture, IBM Corporation's POWER computer architecture and instruction set architecture, IBM Corporation's POWER4/POWER5/POWER6 microarchitecture, and the like.

Examples of such platforms include, Microsoft's Windows XP operating system and software platform, Microsoft's Windows Vista operating system and software platform, the Linux operating system and software platform, Sun Microsystems' Solaris operating system and software platform, IBM Corporation's AIX operating system and software platform, Sun Microsystems' JAVA platform, Microsoft's .NET platform, and the like.

When implemented in a non-JAVA language or application code environment, the generalized platform, and/or virtual machine and/or machine and/or runtime system is able to operate application code 50 in the language(s) (including for example, but not limited to any one or more of source-code languages, intermediate-code languages, object-code languages, machine-code languages, and any other code languages) of that platform, and/or virtual machine and/or machine and/or runtime system environment, and utilize the platform, and/or virtual machine and/or machine and/or runtime system and/or language architecture irrespective of the machine manufacturer and the internal details of the machine. It will also be appreciated in light of the description provided herein that platform and/or runtime system may include virtual machine and non-virtual machine software and/or firmware architectures, as well as hardware and direct hardware coded applications and implementations.

For a more general set of virtual machine or abstract machine environments, and for current and future computers and/or computing machines and/or information appliances or processing systems, and that may not utilize or require utilization of either classes and/or objects, the structure, method, and computer program and computer program product are still applicable. Examples of computers and/or computing machines that do not utilize either classes and/or objects include for example, the x86 computer architecture manufactured by Intel Corporation and others, the SPARC computer architecture manufactured by Sun Microsystems, Inc and others, the PowerPC computer architecture manufactured by International Business Machines Corporation and others, and the personal computer products made by Apple Computer, Inc., and others. For these types of computers, computing machines, information appliances, and the virtual machine or virtual computing environments implemented thereon that do not utilize the idea of classes or objects, may be generalized for example to include primitive data types (such as integer data types, floating point data types, long data types, double data types, string data types, character data types and Boolean data types), structured data types (such as arrays and records) derived types, or other code or data structures of procedural languages or other languages and environments such as functions, pointers, components, modules, structures, references and unions.

In the JAVA language memory locations include, for example, both fields and elements of array data structures. The above description deals with fields and the changes required for array data structures are essentially the same mutatis mutandis.

It will be appreciated that synchronization used herein means or implies “exclusive use” or “mutual exclusion” of an asset or resource. Conventional structures and methods for implementations of single computers or machines have developed some methods for synchronization on such single computer or machine configurations. It will therefore be understood in light of the description provided here that the invention further includes any means of implementing thread-safety, regardless of whether it is through the use of locks (lock/unlock), synchronizations, monitors, semphafores, mutexes, or other “mutual exclusion”-like mechanisms.

The term “Acquire lock” used herein is to be understood to include within its scope a commencement of operation or execution of a mutual exclusion operation, generally corresponding to a particular asset such as a particular memory location or machine resource, and result in the asset corresponding to the mutual exclusion operation being locked with respect to some or all modes of simultaneous or concurrent use, execution or operation. Similarly, the term “Release lock” used herein is to be understood to include within its scope any terminated or otherwise discontinued operation or execution of a mutual exclusion operation, generally corresponding to a particular asset such as a particular memory location or machine resource, and result in the asset corresponding to the mutual exclusion operation being unlocked with respect to some or all modes of simultaneous or concurrent use, execution or operation.

Any and all embodiments of the present invention are able to take numerous forms and implementations, including in software implementations, hardware implementations, silicon implementations, firmware implementation, or software/hardware/silicon/firmware combination implementations.

Various methods and/or means are described relative to embodiments of the present invention. In at least one embodiment of the invention, any one or each of these various means may be implemented by computer program code statements or instructions (possibly including by a plurality of computer program code statements or instructions) that execute within computer logic circuits, processors, ASICs, microprocessors, microcontrollers, or other logic to modify the operation of such logic or circuits to accomplish the recited operation or function. In another embodiment, any one or each of these various means may be implemented in firmware and in other embodiments such may be implemented in hardware. Furthermore, in at least one embodiment of the invention, any one or each of these various means may be implemented by a combination of computer program software, firmware, and/or hardware.

Any and each of the aforedescribed methods, procedures, and/or routines may advantageously be implemented as a computer program and/or computer program product stored on any tangible media or existing in electronic, signal, or digital form. Such computer program or computer program products comprising instructions separately and/or organized as modules, programs, subroutines, or in any other way for execution in processing logic such as in a processor or microprocessor of a computer, computing machine, or information appliance; the computer program or computer program products modifying the operation of the computer on which it executes or on a computer coupled with, connected to, or otherwise in signal communications with the computer on which the computer program or computer program product is present or executing. Such computer program or computer program product modifying the operation and architectural structure of the computer, computing machine, and/or information appliance to alter the technical operation of the computer and realize the technical effects described herein.

For ease of description, some or all of the indicated memory locations herein may be indicated or described to be replicated on each machine (as shown in FIG. 2A), and therefore, replica memory updates to any of the replicated memory locations by one machine, will be transmitted/sent to all other machines. Importantly, the methods and embodiments of this invention are not restricted to wholly replicated memory arrangements, but are applicable to and operable for partially replicated shared memory arrangements mutatis mutandis (e.g. where one or more memory locations are only replicated on a subset of a plurality of machines, such as shown in FIG. 2B).

To summarize, there is disclosed in a multiple computer environment in which a different portion of an application program written to execute on only a single computer executes substantially simultaneously on a corresponding one of a plurality of computers, each having a local memory and each being interconnected via a communications network, and in which at least one memory location accessible by the plurality of computers is replicated in the memory of each the plurality of computers, and after each occasion at which each the memory location has its contents written to, or re-written, with a new content, an updating count indicative of the sequence of updating is associated with the corresponding memory location, and all the corresponding memory locations of the computers are in due course updated via the communications network with the new content and new updating count, the further improvement comprising the steps of:

(i) prior to initially writing the new content, acquiring a lock on an object, asset or resource,
(ii) recording the name and updating count of all the local memory locations written to prior to releasing the lock,
(iii) releasing the lock, and
(iv) prior to permitting the acquisition of the same lock by another one of the computers, transmitting the updated memory location(s) and most recent updating count(s) to the another one computer, whereby any the computer on acquiring the lock has acquired the new updating count(s).

Preferably there is disclosed in which each the computer has an independent local memory accessible only by the corresponding portion of the application program.

Preferably there is disclosed in which the object, asset or resource locked is the object, asset or resource to which the new content is to be written.

Preferably the method includes the further step of:

(v) transmitting in step (iv) all memory locations and updating counts written to in step (ii).

Preferably the method includes the further step of:

(vi) transmitting in step (iv) all memory locations and only their final updating count as written to in step (ii).

Preferably the method includes the further steps of:

(vii) prior to acquiring the lock, detecting all applications program steps which potentially write to listed memory location(s), and
(viii) recording the name of the listed memory location(s) prior to releasing the lock.

Preferably the detecting all application program steps takes place either before loading, or during loading, or after loading but before execution of the relevant code.

Preferably the recording of the name of the listed memory locations takes place either at the time of detection or at the time of execution of an detected program step.

Preferably the method includes the further step of:

(ix) for each recorded memory location recording all updating counts incremented in step (ii).

Preferably the method includes the further step of:

(x) for each recorded memory location recording only the final updating count as incremented in step (ii).

Further, there is disclosed a computer system comprising a plurality of computers each having a local memory and each being interconnected via a communications network wherein a different portion of an application program written to execute on only a single computer executes substantially simultaneously on a corresponding one of the plurality of computers, at least one memory location accessible by the plurality of computers is replicated in the local memory of each the computer, the memory location including an updating count indicative of the sequence of updating of the memory location, the system further comprising updating means associated with each the computer to in due course update each the memory location via the communications network after each occasion at which each the memory location has its content written to, or re-written, with a new content, and new updating count, and lock means associated with each the computer to acquire a lock on an object, asset or resource, the lock means including a recording means in which is recorded the name and updating count of all the local memory locations written to prior to releasing the lock, and the lock means after releasing the lock and prior to permitting the acquisition of the same lock by another one of the machines transmitting the updated memory location(s) and corresponding updating count(s) to the another one machine, whereby any the machine on acquiring the lock has acquired the new updating count(s).

Preferably the object, asset or resource locked is the object asset or resource to which the new content is written.

Preferably the lock means comprises a lock server computer in addition to the plurality of computers, and also connected to the plurality of computers via the communications network.

Preferably the recording means comprises a look up table.

Preferably the look up table includes all updating counts for each recorded memory location.

Preferably the look up table includes only the final updating count for each recorded memory location.

Preferably the contents of the look up table comprises the address of a memory location at which the updated content is stored.

Furthermore, there is disclosed a plurality of computers interconnected via a communications network and operable to ensure carrying out of the abovementioned methods.

Still furthermore, there is disclosed a computer program product comprising a set of program instructions stored in a storage medium and operable to permit a plurality of computers to carry out the abovementioned methods.

The term “compromising” (and its grammatical variations) as used herein is used in the inclusive sense of “having” or “including” and not in the exclusive sense of “consisting only of”.

I/We claim:

1. A single computer comprising:
a local processor and a local memory coupled with said local processor;
a communications interface permitting coupling of said computer to an external communications network, said communications network being configured to permit said single computer to interconnect and communicate with a multiple computer system including a plurality of computers each having a local memory and each being interconnected via a communications network;
means for executing a partial portion of an application program written to execute on only one conventional computer substantially simultaneously with the execution of a different partial portion of the same application program on a different one of said plurality of computers;
said local memory having a memory location that is accessible by said single computer said memory location including an updating count indicative of a sequence of updating of said memory location in said single computer;
updating means associated with said single computer to in due course update each said memory location via said communications network after each occasion at which each said memory location has its content written to, or re-written, with a new content, and new updating count; and
lock means associated with said single computer to acquire a lock on an object, asset or resource;
said lock means including a recording means in which is recorded the name and updating count of all said local memory locations in said single computer written to prior to releasing said lock; and
said lock means after releasing said lock and prior to permitting the acquisition of the same lock by another one of said plurality of computers transmitting said updated memory location(s) and corresponding updating count(s) to said another one machine,
whereby any said computer on acquiring said lock has acquired the new updating count(s).

2. A method for operating single computer, said method comprising:
operating a local processor and a local memory coupled with said local processor;
operating a communications interface permitting coupling of said computer to an external communications network, said communications network being configured to permit said single computer to interconnect and communicate with a multiple computer system including a plurality of computers each having a local memory and each being interconnected via a communications network;
executing a partial portion of an application program written to execute on only one conventional computer substantially simultaneously with the execution of a different partial portion of the same application program on a different one of said plurality of computers;
making accessible said local memory having a memory location by said single computer, said memory location including or storing an updating count indicative of a sequence of updating of said memory location in said single computer;
in due course updating each said memory location associated with said single computer via said communications network after each occasion at which each said memory location has its content written to, or re-written, with a new content, and new updating count; and
acquiring a lock on an object, asset or resource associated with said single computer;
recording the name and updating count of all said local memory locations in said single computer written to prior to releasing said lock; and
after releasing said lock and prior to permitting the acquisition of the same lock by another one of said plurality of computers transmitting said updated memory location(s) and corresponding updating count(s) to said another one machine.

3. A computer program product stored in a computer readable media, the computer program including executable computer program instructions and adapted for execution by at least one computer to modify the operation at least one computer, the modification of operation including performing a method operable to permit a computer to carry out the method up as defined in claim 2.
